(19) United States
(12) Patent Application Publication
(10) Pub. No.: US 2012/0227760 A1
(43) Pub. Date: Sep. 13, 2012

(54) Dental Hygiene Kit

(75) Inventor: Luis Medina Anguiano, Jalisco (MX)

(73) Assignee: Cigarsolo, S.A. DE C.V., Jalisco (MX)

(21) Appl. No.: 13/416,709

(22) Filed: Mar. 9, 2012

(30) Foreign Application Priority Data
Mar. 11, 2011 (ES) 201130262

(51) Int. Cl. A61C 17/00; A61C 15/04; A45D 44/18

(52) U.S. Cl. 132/309

(57) ABSTRACT

The present invention comprises a dental hygiene kit that includes folding implements or assembly implements such as toothbrush, toothpaste, a dental floss device inside a portable capsule and that because of its characteristics this may be used in vending machines.

### PURPOSE OF THE INVENTION

The purpose of the present utility patent application is to register a dental hygiene kit that brings together in a reduced dimensions container all the necessary elements for a good dental maintenance.

### FIELD OF THE INVENTION

Accessories forming the dental hygiene kit are used through mechanical means, for this reason it is considered that the field of the invention is eminently of this kind: mechanical.

### BACKGROUNDS

It is well known the fact that the maintenance of dental hygiene involves a periodical cleaning of dental pieces after each meal. Also it is known, that the dental pieces cleaning includes the use of toothbrush, a tube of toothpaste and sometimes the dental floss. It is evident, that for a person that travels frequently to take his/her necessary elements for a correct dental hygiene ends up being an inconvenient, since the above mentioned elements occupy space, normally a case, that should accompany the user.

In addition to the foregoing, the applicant does not know a dental hygiene kit as those described in this memory.

The dental hygiene kit, purpose matter of the present registration, overcomes the above mentioned inconvenient, also providing other additional advantages that will be evident from the following description.

In addition to those advantages due to is portability, the accessories are integrated into a capsule and placed in a such way that handles of implements, wherever the user employs them, are accommodated inside the closed capsule containing the same

Another invention kit benefit is that thanks to its spherical configuration, this may be used as product to be offered in vending machines.

Also, the kit closing makes possible that elements inside the same are duly protected, since the threaded closing prevents accidental opening of both bodies.

One last advantage aspect of the present invention is that the kit has low manufacturing cost.

To complete the description below and in order to help to understand better its characteristics, attached to the present descriptive memory it is a set of plans in which the figures, in an illustrative manner but not limited, represent the more important details of the invention.

### DESCRIPTION

The characteristic details of this new dental hygiene kit are clearly shown in the following description and drawings attached to the present, as well as a description of the same and following the same reference symbols to indicate parts and figures shown.

### BRIEF FIGURE DESCRIPTION

FIG. 1.—This shows a perspective conventional and exploded view and in use conditions of extended accessories included in the dental hygiene kit.

FIG. 2.—This shows a conventional perspective front view of the dental hygiene kit, with accessories accommodated inside the capsule containing the same.

FIG. 3.—It shows a conventional perspective back view of the dental hygiene kit with accessories accommodated inside the capsule containing the same.

In front of the above mentioned figures and according to the numbers adopted, it is observed in the same a preferred embodiment although no limited of the invention, which consist of one dental hygiene kit that brings together in a reduced dimensions container all the necessary elements for a good dental maintenance.

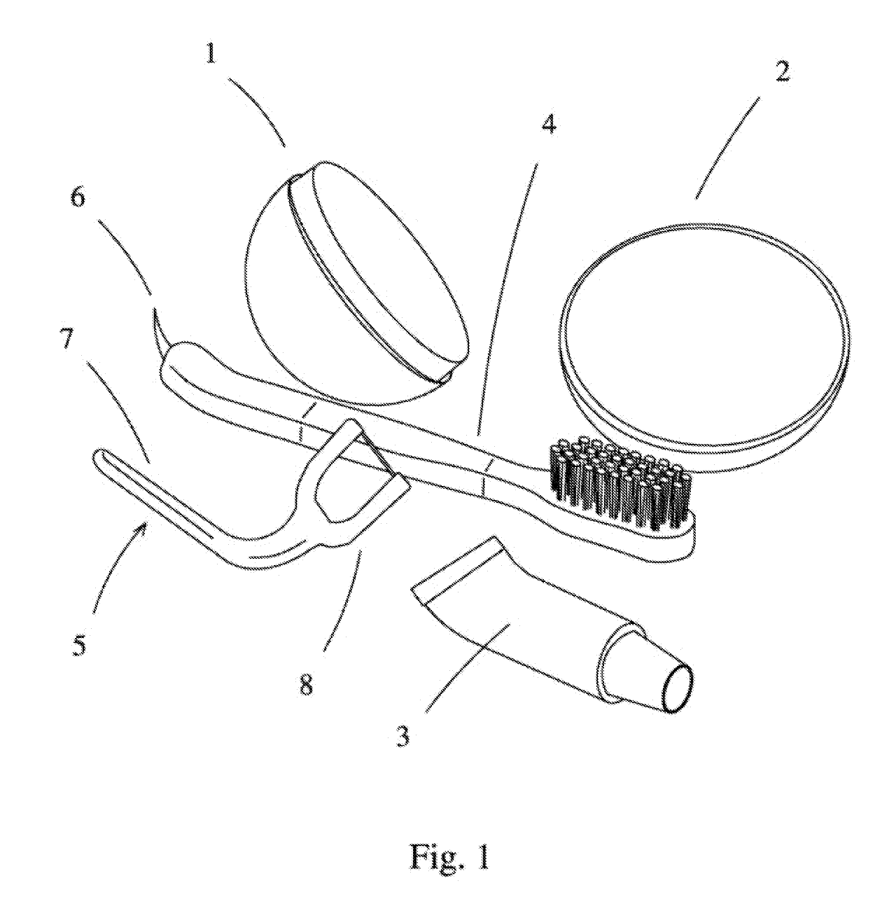

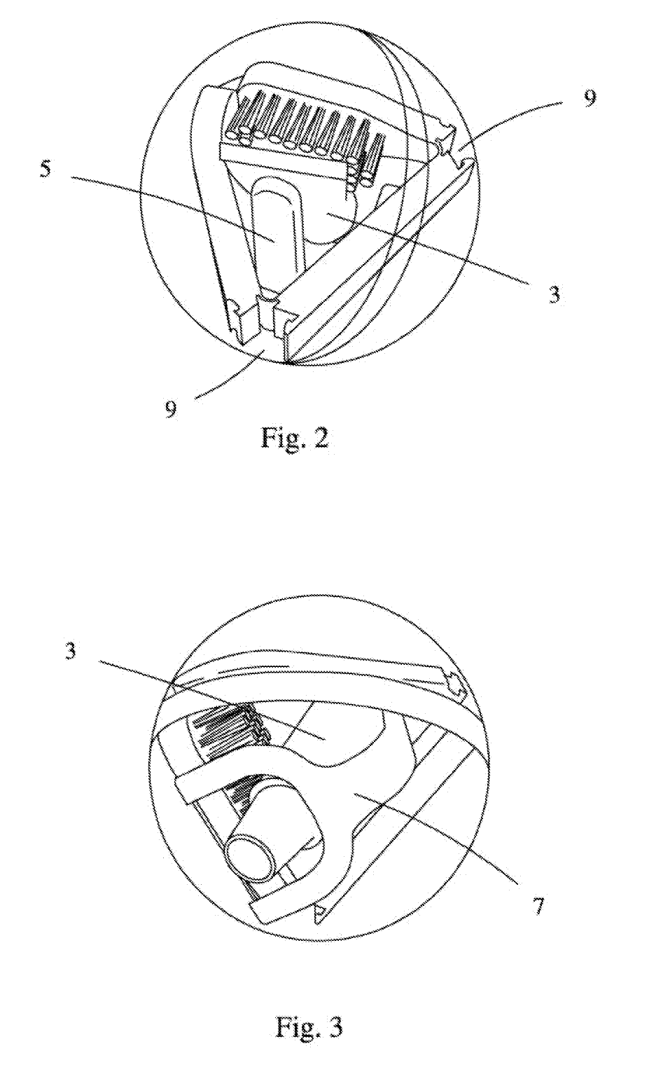

More specifically, as shown in FIG. 1, the kit comprises two bodies internally hollow 1 and 2 facing each other and fit together that determine an inner closed compartment, having the mentioned compartment one toothpaste container 3, a toothbrush 4 and one applicator of dental floss 5; the two bodies 1 and 2 show a skullcap form, in such a way that in a non use condition, the kit adopts a general spherical (refer to FIGS. 2 and 3), due to each of the bodies is provided with a threaded portion, which is a complementary part with respect to the other, placed at the edge of the skullcap, so that the kit closes hermetically protecting the elements inside the same, another dental hygiene element included in the kit is a toothbrush that has at least three folding sections or parts that are assembled by hinges 9 that make possible that the toothbrush 4 adopts reduced dimensions to fit inside the compartment; Complementarily, the dental toothbrush 4 shows an extension 6 with a sharp end that makes possible to use the same as toothpick; finally the dental hygiene kit comprises a dental floss applicator element 5, this has a body with a section as handle 7 and and second section as fork 8 in which it is placed the dental floss; according to one last characteristic the two bodies 1 and 2 are made normally of transparent plastic material, in such a way, that it's very easy to see the elements inside the compartment.

Details, forms and dimensions and other accessory elements, as well as materials used to make the dental hygiene kit of the invention may be conveniently replaced by others that may be technically equivalent, without departing neither from the invention essentiality nor from the scope detailed in the claims attached to the present.

Preferably, the two bodies are made of transparent plastic material, so that the visualization of elements contained in the interior is easy. In accordance with the characteristics described, it is obtained a functional and new kit that makes possible to bring together all necessary elements for a dental correct maintenance in a reduced space. So that, any person can take the invention kit permanently, if desired, and to proceed with the dental hygiene at any moment.

Having been described enough my invention, which I consider a novelty and so that, I claim as exclusive those contained in the following claims:

1. The dental hygiene kit characterized because it comprises two bodies internally hollow and facing each other and fit together that determine an inner closed compartment, having each one of the bodies one threaded part which is complementary with respect to the other part, place at the edge of the each body and said internal compartment has at least one toothpaste, one toothbrush, one dental floss applicator element.

2. The dental hygiene kit, according to claim 1, characterized because the two bodies has a skullcap form and inside the same are placed the implements this may include.

3. The dental hygiene kit, in accordance to claim 1, characterized because the two bodies are normally of plastic material.

4. The dental hygiene kit, according to the first claim, characterized because the two bodies are made of transparent material.

5. The dental hygiene kit, according to claim 1, characterized because the toothbrush includes folding sections or sections that are assembled by hinges.

6. The dental hygiene kit, according to claim 1, characterized because the toothbrush has an extension with a sharp end.

7. The dental hygiene kit, according to claim 1, characterized because the dental floss applicator element has a handle section and a second fork section in which it is placed the floss.
